(19) United States
(12) Patent Application Publication
(10) Pub. No.: US 2026/0222822 A1
(43) Pub. Date: Jul. 30, 2026

(54) LAWFUL INTERCEPTION USING PRIVATE SET INTERSECTION

(71) Applicant: Telefonaktiebolaget LM Ericsson (publ), Stockholm (SE)

(72) Inventors: Mukesh THAKUR, Espoo (FI); Patrik SALMELA, Espoo (FI); Santeri PAAVOLAINEN, Masala (FI)

(21) Appl. No.: 19/145,617

(22) PCT Filed: Jan. 5, 2023
(86) PCT No.: PCT/SE2023/050007

§ 371 Date: Jul. 3, 2025

(51) Int. Cl. H04W 12/80; H04W 12/06; H04W 12/72; H04W 60/04

(52) U.S. Cl. CPC H04W 12/80; H04W 12/06; H04W 12/72; H04W 60/04

(57) ABSTRACT

There is disclosed a method performed by a second network node (102) in a home network for a UE (110) that is a potential target UE for a LI network node including a list of target UEs. Each target UE is identified by a target subscription identifier. The method comprises: receiving a registration request message from a first network node (101) in the visiting network. The registration request message comprises a SUCI of the potential target UE and an indication of a masked target subscription identifier masked according to a first step of a PSI. The masked target subscription identifier is based on a target subscription identifier of a target UE; obtaining a result by a result step of the PSI on the masked target subscription identifier and the subscription identifier corresponding to the SUCI; and sending an authentication success message comprising the result to the first network node.

### TECHNICAL FIELD

The present disclosure relates to lawful interception using private set intersection techniques.

### BACKGROUND

One of the improvements for customer privacy in Fifth Generation (5G) communication networks is the hiding of the subscriber identity during network registration of a user equipment (UE). In Fourth Generation (4G) communication networks, International Mobile Subscriber Identity (IMSI) is sent in plaintext in the network attachment request, allowing anyone with access to the radio spectrum to track and trace subscribers. However, in the 5G authentication process, i.e. 5G Authentication and key agreement (AKA) described in, for example, 3GPP TS 33.501 Release 17 version 17.7.0 (2022-09-22), the UE sends its identity i.e. subscription permanent identifier (SUPI) in encrypted form as subscriber concealed identity (SUCI). The SUCI is protected both against eavesdropping as well as against external parties tracking the UE. This is due to that firstly the identity is protected with keying material derived from an ephemeral non-interactive Diffie-Hellman key exchange with the UE's home public land mobile network (HPLMN), and secondly, the ephemeral key used for key derivation is randomized for each registration.

However, since the SUPI in 5G is now no longer available for the visited public land mobile network (VPLMN) during roaming, this raised an issue as to how a lawful intercept (LI) node could target specific UEs in the VPLMN. To meet this requirement, HPLMN sends SUPI back to the VPLMN during UE registration. To thwart the possibility of home network hiding the true SUPI of the device, the SUPI is used to generate the keying material at a security anchor function (SEAF) node. During 5G-AKA, since the UE is not in direct communication with the HPLMN, it is assumed that the SUPI (encrypted form as SUCI) must be identical to the SUPI provided by the HPLMN. This is because the K_{gNB} key derived in the UE, that is derived at the SEAF/Access and Mobility Management Function (AMF) and that is sent to the radio access network (RAN) is used to protect UE to RAN communication traffic. Any difference in the derived values of the key would prevent any further communication from occurring, effectively preventing the UE from having access to the network.

While 5G SUCI increases privacy of the subscriber's identity over the radio spectrum, making subscriber identity hidden for third parties, SUPI is still visible to the VPLMN. This means, that a VPLMN may, itself, identify the subscription of any UE and track the UE within the network, even if there is no agreement between the subscription holder and the VPLMN.

### SUMMARY

An object of the present disclosure is to improve security and/or privacy in a communication network.

To overcome the said object, according to a first aspect there is provided a method performed by a first network node in a visiting network for a user equipment, UE, that is a potential target UE for a Lawful Intercept, LI, network node, wherein the LI network node includes a list of target UEs, each target UE of the list being identified by a target subscription identifier. The method comprises: sending a registration request message for the potential target UE to a second network node, the second network node being part of a home network for the potential target UE, wherein the registration request message comprises a subscription concealed identifier, SUCI, of the potential target UE and an indication of a masked target subscription identifier masked according to a first step of a private set intersection, PSI, and wherein the masked target subscription identifier is based on a target subscription identifier of a target UE of the list. The method comprises receiving an authentication success message from the second network node, wherein the authentication success message comprises a result obtained by a result step of the PSI on the masked target subscription identifier and the subscription identifier corresponding to the SUCI of the potential target UE. The method comprises sending the result to the LI network node.

In one or more embodiments according to the first aspect, the method further comprises receiving the SUCI from the potential target UE.

In one or more embodiments according to the first aspect, the authentication success message further comprises a pseudonymous identifier for the subscription identifier of the potential target UE.

In one or more embodiments according to the first aspect, the method further comprises sending the pseudonymous identifier to the LI network node.

In one or more embodiments according to the first aspect, the method further comprises sending the pseudonymous identifier to the LI network node together with the result.

In one or more embodiments according to the first aspect, the method further comprises storing the masked target subscription identifier in the first network node, or storing an indication of the masked target subscription identifier in the first network node.

In one or more embodiments according to the first aspect, the masked target subscription identifier contained in the registration message corresponds to a target UE belonging to the same home network as the potential target UE.

In one or more embodiments according to the first aspect, the second network node is an authentication server function.

In one or more embodiments according to the first aspect, the method further comprises sending a registration request message to a second network node includes sending the registration request message comprising an indication of a subset of masked target subscription identifiers, and wherein the subset of masked target subscription identifiers is based on a corresponding subset of target UEs of the list, wherein all the target UEs of the subset belong to the same home network as the potential target UE.

In one or more embodiments according to the first aspect, the LI network node is comprised in the visiting network.

According to a second aspect, there is provided a method performed by a second network node in a home network for a user equipment, UE, that is a potential target UE for a Lawful Intercept, LI, network node, wherein the LI network node includes a list of target UEs, each target UE of the list being identified by a target subscription identifier. The method comprises receiving a registration request message for the potential target UE from a first network node in the visiting network, wherein the registration request message comprises a subscription concealed identifier, SUCI, of the potential target UE and an indication of a masked target subscription identifier masked according to a first step of a private set intersection, PSI, and wherein the masked target subscription identifier is based on a target subscription identifier of a target UE of the list. The method comprises obtaining a result by a result step of the PSI on the masked target subscription identifier and the subscription identifier corresponding to the SUCI of the potential target UE. The method comprises sending an authentication success message to the first network node, wherein the authentication success message comprises the result.

In one or more embodiments according to the second aspect, the method further comprises generating a pseudonymous identifier for the subscription identifier of the potential target UE.

In one or more embodiments according to the second aspect, the method further comprises storing the masked target subscription identifier in the second network node or storing an indication of the masked target subscription identifier in the second network node.

In one or more embodiments according to the second aspect, the authentication success message comprises the pseudonymous identifier.

In one or more embodiments according to the second aspect, the second network node is an authentication server function.

According to a third aspect, there is provided a method performed by a Lawful Intercept, LI, network node in a visiting network for a user equipment, UE, that is a potential target UE for the LI network node, wherein the LI network node includes a list of target UEs, each target UE of the list being identified by a target subscription identifier. The method comprises generating an indication of a masked target subscription identifier masked according to a first step of a private set intersection, PSI, and wherein the masked target subscription identifier is based on a target subscription identifier of a target UE of the list. The method comprises sending an indication of the masked target subscription identifier to a first network node in the visiting network for the potential target UE. The method comprises receiving, from the first network node, a result obtained by a result step of the PSI on the masked target subscription identifier and the subscription identifier corresponding to the SUCI of the potential target UE. The method comprises determining whether the subscription identifier of the potential target UE is present as a target subscription identifier of a target UE in the list based on performing a third step of the PSI on the result.

In one or more embodiments according to the third aspect, the method further comprises receiving a registration indication message comprising an identifier of the UE.

In one or more embodiments according to the third aspect, the identifier comprises a first identifier identifying a network and a second identifier identifying a country.

In one or more embodiments according to the third aspect, the wherein the identifier is the SUCI.

In one or more embodiments according to the third aspect, the method further comprises receiving a pseudonymous identifier for the subscription identifier of the UE.

In one or more embodiments according to the third aspect, the method further comprises: associating the pseudonymous identifier with the subscription identifier of the UE; and performing lawful interception on the UE.

In one or more embodiments according to the third aspect, the masked target subscription identifier or the indication of the masked target subscription identifier is stored in at least one of: the first network node and the second network node.

In one or more embodiments according to the first, the second and/or the third aspects, the indication is the masked target subscription identifier.

In one or more embodiments according to the first, the second and/or the third aspects, the indication is a flag indicating the masked target subscription identifier to be used.

In one or more embodiments according to the first, the second and/or the third aspects, the indication is a set of masked target subscription identifiers.

In one or more embodiments according to the first, the second and/or the third aspects, the target subscription identifier is one of: subscriber permanent identifier, SUPI; international mobile subscriber identity, IMSI; and network access identifier, NAI.

In one or more embodiments according to the first, the second and/or the third aspects, the one or more parameters for performing the one or more steps of the PSI are sent, from the LI network node to the second network node via the first network node, together with the indication.

In one or more embodiments according to the first, the second and/or the third aspects, one or more parameters for performing the one or more steps of the PSI are pre-configured in the LI network node and the second network node.

In one or more embodiments according to the first, the second and/or the third aspects, an outcome of the determining is that the subscription identifier of the UE belongs to the list of the target subscription identifiers of the LI.

In one or more embodiments according to the first, the second and/or the third aspects, the one or more target UEs comprised in the list belong to the home network of the UE.

In one or more embodiments according to the first, the second and/or the third aspects, the first network node is one of: security anchor function, and access and mobility management function.

According to a fourth aspect, there is provided a first network node in a visiting network for a user equipment, UE, that is a potential target UE for a Lawful Intercept, LI, network node, wherein the LI network node includes a list of target UEs, each target UE of the list being identified by a target subscription identifier, the first network node comprising a memory and a processor, the memory comprising instructions which when executed on the processor, cause the first network node to: send a registration request message for the potential target UE to a second network node, the second network node being part of a home network for the UE, wherein the registration request message comprises a subscription concealed identifier, SUCI, of the potential target UE and an indication of a masked target subscription identifier masked according to a first step of a private set intersection, PSI, and wherein the masked target subscription identifier is based on a target subscription identifier of a target UE of the list;

receive an authentication success message from the second network node, wherein the authentication success message comprises a result obtained by a result step of the PSI on the masked target subscription identifier and the subscription identifier corresponding to the SUCI of the potential target UE; and send the result to the LI network node.

In one or more embodiments according to fourth aspect, the memory comprising instructions which when executed on the processor, further cause the first network node to perform a method according one or more embodiments of the first aspect.

According to a fifth aspect, there is provided a second network node in a home network for a user equipment, UE, that is a potential target UE for a Lawful Intercept, LI, network node, wherein the LI network node includes a list of target UEs, each target UE of the list being identified by a target subscription identifier, the second network node comprising a memory and a processor, the memory comprising instructions which when executed on the processor, cause the second network node to: receive a registration request message for the potential target UE from a first network node in the visiting network, wherein the registration request message comprises a subscription concealed identifier, SUCI, of the UE and an indication of a masked target subscription identifier masked according to a first step of a private set intersection, PSI, and wherein the masked target subscription identifier is based on a target subscription identifier of a target UE of the list; determine a result obtained by a result step of the PSI on the masked target subscription identifier and the subscription identifier corresponding to the SUCI of the potential target UE; and send an authentication success message to the first network node, wherein the authentication success message comprises the result.

In one or more embodiments according to the fifth aspect, the memory comprising instructions which when executed on the processor, further cause the second network node to perform a method according one or more embodiments of the second aspect.

According to a sixth aspect, there is provided a Lawful Intercept, LI, network node in a visiting network for a user equipment, UE, that is a potential target UE for the LI network node, wherein the LI network node includes a list of target UEs, each target UE of the list being identified by a target subscription identifier, the LI network node comprising a memory and a processor, the memory comprising instructions which when executed on the processor, cause the LI network node to: generate an indication of a masked target subscription identifier masked according to a first step of a private set intersection, PSI, and wherein the masked target subscription identifier is based on a target subscription identifier of a target UE of the list; send an indication of the masked target subscription identifier to a first network node in the visiting network for the UE; receive, from the first network node, a result obtained by a result step of the PSI on the masked target subscription identifier and the subscription identifier corresponding to the SUCI of the potential target UE; and determine whether the subscription identifier of the UE is present in the list based on performing a third step of the PSI on the result.

In one or more embodiments according to the sixth aspect, the memory comprising instructions which when executed on the processor, further cause the LI network node to perform a method according one or more embodiments of the third aspect.

According to a seventh aspect, there is provided a computer program, comprising instructions which when executed on a first network node, cause the first network node to carry out the method according to one or more embodiments of the first aspect.

According to an eighth aspect, there is provided a computer program product, CPP, comprising a computer readable storage means on which the computer program according to the seventh aspect is stored.

According to a ninth aspect, there is provided a computer program, comprising instructions which when executed on a second network node, cause the second network node to carry out the method according to one or more embodiments of the second aspect.

According to a tenth aspect, there is provided a computer program product, CPP, comprising a computer readable storage means on which the computer program according to the ninth aspect is stored.

According to an eleventh aspect, there is provided a computer program, comprising instructions which when executed on a Lawful Intercept, LI, network node, cause the LI network node to carry out the method according to one or more embodiments of the third aspect.

According to a twelfth aspect, there is provide a computer program product, CPP, comprising a computer readable storage means on which the computer program according to the eleventh aspect is stored.

### BRIEF DESCRIPTION OF THE DRAWINGS

FIG. 1 illustrates a flowchart depicting one or more steps of a PSI operation according to one or more embodiments of the invention.

FIG. 2 illustrates a method performed by a first network node according to one or more embodiments of the invention.

FIG. 3 illustrates a method performed by a second network node according to one or more embodiments of the invention.

FIG. 4 illustrates a method performed by a LI network node according to one or more embodiments of the invention.

FIG. 5 illustrates a flowchart according to one or more embodiments of the invention.

FIG. 6 illustrates a first network node according to one or more embodiments of the invention.

FIG. 7 illustrates a second network node according to one or more embodiments of the invention.

FIG. 8 illustrates a LI network node according to one or more embodiments of the invention.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

In the present document, any reference to a UE includes a subscription (or a subscription identifier) of the UE. For example, a UE being a target for lawful interception may refer to a subscription of the UE being a target for lawful interception.

In the present document, it may be noted that even if a subscription (e.g. a Subscriber Identity Module (SIM)) of a UE is transferred to another mobile equipment, it is the subscription that is considered for registration purposes irrespective of the identity of the mobile equipment.

While 5G SUCI increases privacy of the subscriber's identity over the radio spectrum, making subscriber identity hidden for third parties, in solutions according to the prior art SUPI is still visible to the VPLMN. This means that a VPLMN itself may identify the subscription of any UE and track them within the network, even if there is no agreement between the subscription holder and the VPLMN. While a VPLMN might be generally considered trustworthy, the increasing amount of data thefts has raised concerns about sharing data even with apparently trustworthy entities. Further, from the VPLMN point-of-view, the VPLMN is interested in being able to ensure the HPLMN is charged for the roaming of the UE in the VPLMN. As a result, the VPLMN does not need to possess information of SUPI.

With awareness that SUPI is not necessary for the VPLMN as well as the broader societal concerns about customer privacy, it may, thus, be seen as a security and privacy concern to expose SUPI to the VPLMN.

While it is possible for HPLMNs to provide a pseudonymous SUPI credential to a UE for each registration, this approach would require co-operation between the UE and the HPLMN due to how session keys are derived. Further, such approaches may hamper the capacity of law enforcement agencies (LEAs) performing LI operations to target specific subscriber identities.

Another solution would be to hide SUPI from VPLMN but expose it to a LI node of the VPLMN by encrypting the SUPI with VPLMN's LI public key. In this solution, the confidentiality of the SUPI relies on operational isolation between the VPLMN LI functionality and rest of the VPLMN. Since a potential driver for protecting SUPI from remote networks is the concern of data leaks from a trustworthy VPLMN, this solution requires complete trust to be instituted in a mobile network operator's (MNO) network.

Furthermore, another possible solution could be to directly include HPLMN as part of the UE identification procedure during the LI operations. But this solution suffers from the drawback that information on UE that is being targeted may be leaked outside of LI, e.g. to HPLMN or VPLMN. This is not desired since that would allow security agencies at the home network side to determine whether a SUPI is being tracked or not, which is against the principles of LI.

To overcome one or more of the above problems, herein is proposed a method and an apparatus to determine whether a UE in a VPLMN is a LI target which use a method of secure multiparty computation such as private set intersection (PSI). Using PSI, it is possible for a LI node to determine whether a UE's SUPI indeed exists in the LI target list in a way that the SUPI is revealed to the LI node only if the SUPI already exists in the set. If the SUPI is not within the target list, the LI node learns no new information about the SUPI. At the same time, the HPLMN does not learn any information about the LI's target list or whether the given SUPI is being targeted. Further, the VPLMN learns no additional information about the SUPI besides those already in its possession.

The invention thus enables hiding subscriber identity from the VPLMN, while allowing SUPI to be correctly identified for subscribers targeted by LI in the VPLMN.

A brief description of the PSI is provided below followed by detailed explanation of one or more embodiments of the invention.

### Private Set Intersection

In general terms, PSI is a technique that enables two parties to compute an intersection of private sets of their data without revealing anything but the actual intersection. Preferably, the intersection is revealed to one of the two parties only (this PSI is called asymmetric PSI): An example description of PSI may be found in “Practical Private Set Intersection Protocols with Linear Computational and Bandwidth Complexity”, De Cristofaro, E., & Tsudik, G., IACR Cryptol. ePrint Arch., 2009, 491. (https://www.researchgate.net/profile/Emiliano-De-Cristofaro/publication/220797059 Practical Private Set Intersection Protocols with Line ar_Complexity/links/02e7e51f7d4951309e000000/Practical-Private-Set-Intersection-Protocols-with-Linear-Complexity.pdf).

Many types of different PSI exist, which use different cryptographic protocols. In the present invention any PSI can be used, preferably an asymmetric PSI is selected. Furthermore, as an example, homomorphic encryption is used in a preferred embodiment of PSI. Homomorphic encryption is a technique in which computations can be performed on encrypted messages without knowing the plain (non-encrypted) message. Such a computation yields an encrypted result, which when decrypted is the same as if the computation would have been performed on plain text.

While the details vary between different specific PSI protocols, the overall idea is that there are two parties, a client C with set X and a server S with set Y. The goal of the PSI protocol is that neither client nor server learns about the contents of the other's set, except that the client learns the intersection XNY.

‘∩’ denotes a PSI intersection representing one or more elements (or content) in common to both the sets.

A brief explanation of a PSI procedure is provided below:
1. At the client, X is masked as X*. For example, X* is calculated using a certain encrypting function E having key k: X*=E(X,k). The property of X* is that without knowing the generating parameters (e.g., key k), no element of X can be retrieved from X*. The term ‘mask’ may refer to encrypting/concealing/hiding/encoding information such that the information may be decrypted/derived/retrieved/decoded only by knowing some generating parameters. ‘*’ may denote a masking operation.
2. X* is sent to the server, which calculates an operation over X*and Y. For example, the operation performed is, X*Y=I(X*, Y). The result of the operation (i.e. X*Y) performed over the encrypted (masked) set X* and the original (unmasked) set Y is as if it were performed over the unmasked X and Y sets (and then encrypted) due to the properties of the operations performed.
3. The result of I(X*, Y) is sent back to the client. In other words, X*Y is sent back to the client.
4. The client may use the generating parameters (e.g., key k) to extract X∩Y without learning individual elements from the Y set, using a certain decrypting (unmasking) function D: X∩Y=D(X*Y, X, k). In practice, the client may iterate through X and test whether the masked computation succeeded for a particular value (indicating whether the particular value was present in the PSI intersection) or did not succeed (indicating whether the particular value was not present in the PSI intersection).

There are many categories of PSI protocols. A PSI protocol may be based on Oblivious Polynomial Evaluations (OPE-s), e.g. Freedman, Nissim, and Pinkas (FNP). Alternatively, some PSI protocols may rely on Oblivious Pseudo-Random Functions (OPRF-s). A third category of PSI protocol may be Authorized Private Set Intersection.

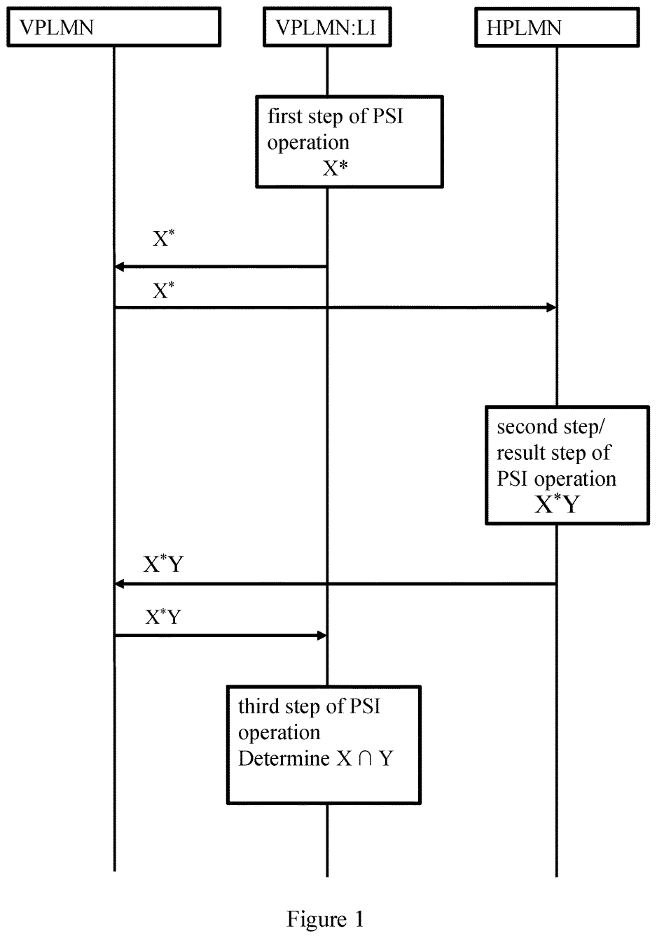

FIG. 1 illustrates a general procedure for performing a PSI operation using FNP PSI scheme according to one or more embodiments of the invention. In the FNP PSI protocol, the VPLMN LI encodes the target set X as roots of a polynomial, whose coefficients are homomorphically encrypted and sent to the HPLMN. The HPLMN would then perform homomorphic computation of the Y set over the homomorphically encrypted coefficients and send the result back to the VPLMN. The result, due to the properties of homomorphic computation, remains encrypted by the private key known only by the VPLMN LI, thus the result of the polynomial evaluation remains unknown to all but the VPLMN LI. Further technical details and mathematical operations may be found in Freedman, M. J., Nissim, K., Pinkas, B. (2004). “Efficient Private Matching and Set Intersection.” In: Cachin, C., Camenisch, J. L. (eds) Advances in Cryptology-EUROCRYPT 2004. EUROCRYPT 2004. Lecture Notes in Computer Science, vol 3027. Springer, Berlin, Heidelberg. (https://doi.org/10.1007/978-3-540-24676-3_1).

FIG. 1 is further described below. It may be noted that the procedure described below is applicable to other PSI schemes as well:
1. A warrant for LI for one or more UEs (or a subscription of a UE) is issued at the VPLMN. These UEs may be referred to as target UEs. A UE may then register itself at the VPLMN and may be referred to as potential target UE 110. The VPLMN LI may want to check whether the potential target UE that just registered at the VPLMN is among LI's target UEs. Thus, the VPLMN LI first identifies a set of SUPIs to be tracked for a specific HPLMN. Let X=(x₁, . . . , xₙ) be this set;
2. The VPLMN LI then performs a first step of PSI operation to mask X to X* as described below:
   a. Encode xᵢϵX as roots of a n-degree polynomial P(y)=(x₁−y)( . . . )(xₙ−y)=Σᵢαᵢ yⁱ;
   b. Let pkₓ be VPLMN LI's public key in the PSI;
   c. X* is generated from P (y) coefficients by homomorphically encrypting them with the PSI public key pkₓ. X* may be the homomorphic encryption of P(y) coefficients;
3. X* is sent from VPLMN to HPLMN;
4. Let Y=(SUPI) be the SUPI stored in the HPLMN;
5. The HPLMN computes a second step (or a result step) of PSI operation to obtain the PSI intersection. The second step of PSI operation is applied to set X* by homomorphically evaluating the polynomial encoded by X* for every member of the Y set to obtain a result, wherein the result may remain encrypted using the private key from step 2c;
6. The obtained result is sent to VPLMN and back to VPLMN LI;
7. The VPLMN LI then performs a third step of the PSI operation to homomorphically decrypt the result using its private key, and further identifying if the potential target UE is indeed part of the VPLMN LI's target list of UEs.
In case of FNP, the VPLMN LI may identify which roots in the result evaluate to zero. The roots evaluating to zero correspond to SUPIs from the X set. If the result is non-zero, no information of the Y set is leaked. This enables the VPLMN LI to identify and obtain the SUPI that is part of the VPLMN LI's target list. The VPLMN LI may for example determine the SUPI that is indeed part of the VPLMN LI's target list based on which root evaluates to zero.

It may be noted that the first step, the second step/the result step and the third step may all be performed as part of the same PSI operation or PSI protocol.

It may further be noted that the HPLMN receives X* i.e. the masked set of X, which does not reveal any information to the HPLMN about the VPLMN/LI targets, except perhaps size of the list of targets, However, padding may be used to hide the actual size.

Further, the HPLMN may not know if a specific UE is under LI at the VPLMN. Additionally, if there is no LI warrant for the UE, no part of the VPLMN, including the LI, will learn about the actual subscription identifier of the UE. If there is a warrant on the UE and there is a resulting intersection with the subscriber identifier belonging to the HPLMN, then only the VPLMN LI will learn about the subscription identifier and no other part of the VPLMN.

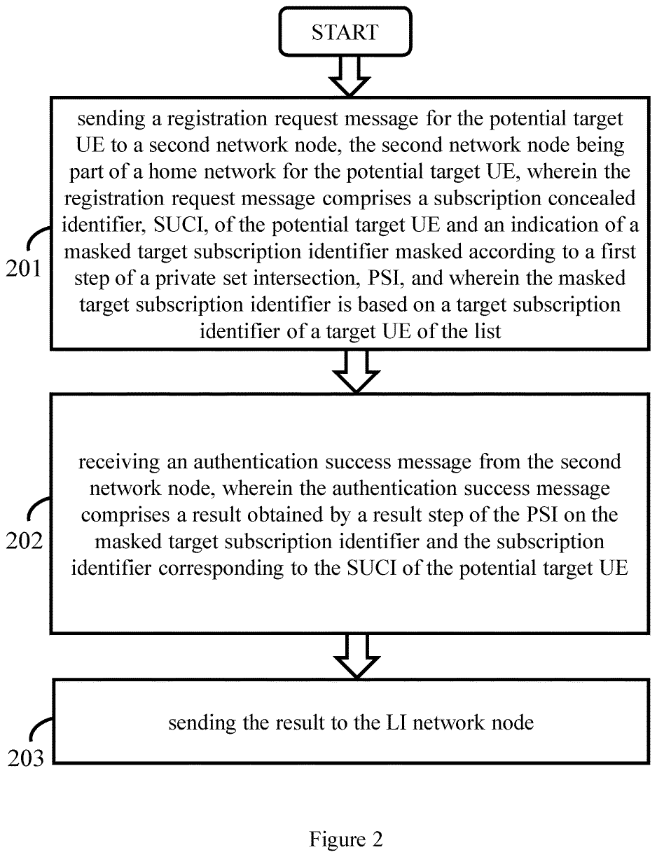

FIG. 2 illustrates a method according to one or more embodiments. The method is performed by a first network node 101 in a visiting network for a UE 110. The first network node 101 may, for example, be a SEAF or an AMF. The visiting network may for example, be the VPLMN for the UE 110. The UE 110 may be a potential target for a LI network node 103. The LI network node 103 typically includes a list of targets. A target may refer to a UE (or a subscription of UE) against which a warrant for lawful interception has been issued, e.g by an LEA. The list of targets may thus include information related to subscriptions of the UEs against which a warrant for lawful interception has been issued. The UE 110 may thus be a potential target UE against which an LEA may or may not have issued a warrant for lawful interception

At Step 201, the method starts with the first network node 101 sending a registration request message for the potential target UE 110 to a second network node 102. The registration request message sent from the first network node 101 to the second network node 102 is herein referred to as second registration request message.

The second network node 102 may be part of a home network for the potential target UE. The second network node 102 may, for example, be part of the HPLMN. In one or more embodiments, the second network node 102 is an Authentication Server Function (AUSF).

The second registration request message may, for example, be a 5G or a 6G registration request message. The second registration request message may comprise a concealed identifier of the potential target UE. The concealed identifier may, for example, be a subscription concealed identifier, SUCI, of the potential target UE.

The SUCI may be received from the potential target UE, for example, via a registration request message sent from the UE 110 to the first network node 101. The registration request message sent from the UE 110 to the first network node 101 is herein referred to as a first registration request message. The SUCI of the potential target UE enables the first network node 101 to direct or send the second registration request message to the correct HPLMN of the potential target UE, without knowing the subscription identifier of the potential target UE. Optionally, the first registration request message is not forwarded in its entirety, but only a part of the first registration request message is forwarded. For example, instead of the SUCI; only the MNC and/or MCC are forwarded.

The second registration request message sent by the first network node 101 to the second network node 102 may further comprise, in addition to the concealed identifier of the potential target UE, an indication of a masked target subscription identifier. This is exemplified in Step 3 of FIG. 1 above. The masked target subscription identifier may refer to a masked or hidden form of a target subscription identifier of a target UE of a list of target UE identifiers. The masked target subscription identifier may be based on a target subscription identifier of a target UE of the list. In one or more embodiments, the target subscription identifier is a SUPI of a target UE. In another embodiment, the target subscription identifier is international mobile subscriber identity, IMSI of a target UE. In yet another embodiment, the target subscription identifier is a network access identifier, NAI, of a target UE. The first network node 101 may receive the indication of the masked target subscription identifier from the LI network node 103.

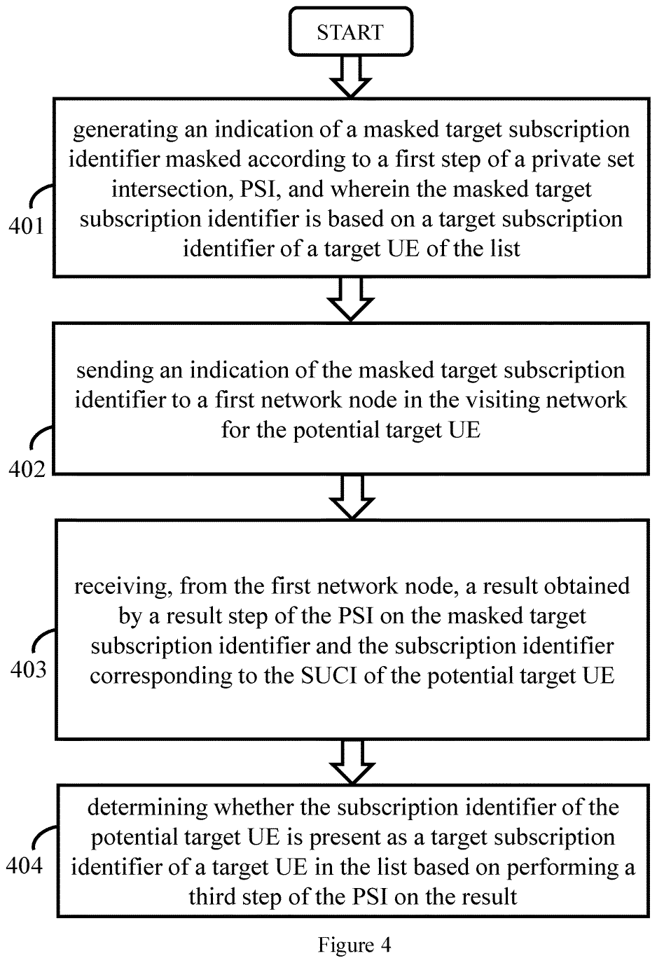

The masking of the target subscription identifier does not reveal information about VPLMN/LI targets to the second network node 102, e.g., belonging to the HPLMN. The masking of the target subscription identifier may for example be carried out according to Step 1 under the section ‘Private Set Intersection’. The masking of the target subscription identifier may for example be carried out according to Steps 2a-2c of FIG. 1. Further details on how masking is performed at the LI network node 103 will be described below with respect to FIG. 4.

In one or more embodiments, the indication is the masked target subscription identifier. In one or more embodiments, the indication is a flag indicating the masked target subscription identifier to be used. In one or more embodiments, the indication is a set of masked target subscription identifiers.

In an embodiment, the masked target subscription identifier is based on the subscription identifier of a target UE having the second network node 102 belonging to the target UE's HPLMN. If the registration message (e.g. a registration indication message and/or second registration request message) includes more than a indication of a masked target subscription identifier, preferably all the masked target subscription identifiers are based on the subscription identifier of target UEs all having the second network node 102 belonging to the target UEs' HPLMN. The target subscription identifiers of the target UEs all having the second network node 102 belonging to the target UEs' HPLMN form a subset of all target subscription identifier forming the list in the LI network node 103. In an embodiment, the LI network node 103 masks only the subset of target subscription identifiers and sends to the first network node 101 only an indication of the subset of masked target subscription identifiers. In such embodiments, the first network node 101 sends, to the second network node 102, the second registration request message comprising an indication of the subset of masked target subscription identifiers.

Preferably, the subset of masked target subscription identifiers is based on a subset of target subscription identifiers all having the second network node 102 belonging to their HPLMN, which in turn is the same HPLMN of the potential target UE. As mentioned earlier, the LI network node 103 may receive the whole or part of the SUCI of the potential target UE. The LI network node 103 may determine the HPLMN of the potential target UE 110 based on information comprised in the SUCI, for example, based on the home network identifier and/or the SUPI type. The home network identifier identifies the home network of the UE 110 and the SUPI type identifies the type of the SUPI concealed in the SUCI. For example, if the SUPI type is 0 indicating that an IMSI is concealed in the SUCI, then the home network identifier comprises a mobile country code (MCC) and a mobile network code (MNC). As another example, if the SUPI type is 1 indicating a network access identifier is concealed in the SUCI, then the home network identifier is a string of characters with a variable length representing a domain name. The LI network node 103 may then select the subset of the list of the target subscription identifiers that have the same home network identifier (and thus the same HPLMN) as the potential target UE. The LI network node 103 may then perform a first PSI operation on this subset of the target subscription identifiers and obtain the subset of masked target subscription identifiers. This subset of masked target subscription identifiers may then be sent to the first network node 101.

The first network node 101 may further store the indication of the masked target subscription identifier. The first network node 101 may for example store the indication in a generic memory comprised in the first network node 101. The first network node 101 may for example store the indication in a secure element comprised in the first network node 101. The secure element may further be protected by other encryption mechanisms. The indication may further be retrieved by the first network node 101 from the memory or the secure element and may be sent to the second network node 102. By storing the indication of the masked target subscription identifier in the first network node 101, there is no need for the LI network node 103 to generate and send the masked target subscription identifier to the first network node 101 each time a new potential target UE registers to the first node, thus saving power consumption due to processing, saving bandwidth and reducing processing time.

At Step 202, the method further comprises receiving an authentication success message from the second network node 102. The authentication success message may, for example, be a 5G authentication success message or a 6G authentication success message. The authentication success message may be received based on successful authentication at the second network node 102. The authentication success message may be received as a response to the second registration request message earlier sent by the first network node 101.

The authentication success message may comprise a PSI result. The PSI result may be obtained by a result step of the PSI between the masked target subscription identifier and a subscription identifier corresponding to the SUCI of the potential target UE. The result is based on a result step of PSI as exemplified in, step 5 of FIG. 1 above and/or Step 2 under the section ‘Private Set Intersection’. The result is encrypted and therefore its content is not readable with the exception of the node which made the first PSI step, in this case the LI network node 103.

In one or more embodiments, the authentication success message further comprises a pseudonymous identifier for the subscription identifier of the potential target UE. The pseudonymous identifier may be used to further increase the privacy of the subscriber's identity wherein the pseudonymous identifier is sent to the first node 101 instead of the subscription identifier of the potential target UE. The pseudonymous identifier may, for example, be a pseudonymized form of one of: SUPI, IMSI and NAI of the potential target UE.

At Step 203, the method comprises sending by the first network node 101 the result to the LI network node 103. The LI network node 103 then may perform the third step of the PSI in order to decrypt the result. The decryption of the result gives the intersection between the target subscription identifier in the list and the subscription identifier of the potential target UE. More generally, the decryption of the result gives the intersection between the subset of target subscription identifier and the subscription identifier of the potential target UE. This enables the LI network node 103 to determine whether the potential target UE 110 is indeed a target UE, e.g., whether the SUPI of the potential target UE 110 belong to the list of target subscription identifiers. For example, if the decryption of the result gives zero, then the potential target UE 110 is a target UE. The LI network node 103 may, for example, perform the third step of the PSI according to Step 4 under the section ‘Private Set Intersection’ and/or Step 7 of FIG. 1.

In one or more embodiments, the first network node 101 may send the pseudonymous identifier to the LI network node 103. The result and the pseudonymous identifier may be sent together in a single message or sent in separate messages. The message may for example be a response message to a registration indication message received from the LI network node 103 as will be detailed further with respect to FIG. 4. In one or more embodiments, the first network node 101 may further send the pseudonymous identifier to the UE 110 that is a potential target UE, to enable generation of keying material such as K_{gNB} at the UE 110. This may further be done to inform UE about the pseudonymous identifier being used in the network. In some alternate embodiments, the UE 110 that is a potential target UE may itself generate the pseudonymous identifier that is being used in the network.

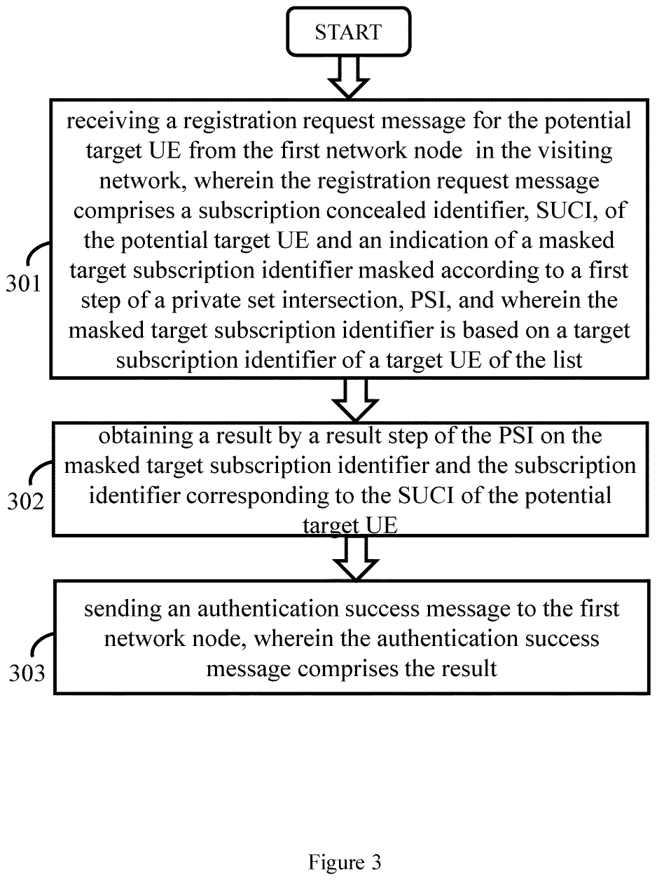

FIG. 3 illustrates a method according to one or more embodiments. The method is performed by the second network node 102. The second network node 102 may be in the home network node for the UE 110 that is a potential target UE for the LI network node 103. The second network node 102 may for example be an AUSF. The method is now explained from the perspective of the second network node 102.

At Step 301, the method starts with the second network node 102 receiving a second registration request message for the potential target UE 110 from the first network node 101 in the visiting network. The second registration request message may comprise the SUCI of the potential target UE 110 and an indication of the masked target subscription identifier. The description of the indication of the masked target subscription identifier has been already given with reference to FIG. 2 and not repeated herein. The SUCI of the potential target UE 110 enables in identifying corresponding subscription identifier in the second network node 102.

The indication of the masked target subscription identifier enables in computing a result step of the PSI operation, which will be explained further below.

The second network node 102 may further retrieve the indication of the masked target subscription identifier from the first network node 101. After retrieving the indication of the masked target subscription identifier, the second network node 102 may also store the indication, for example in a suitable memory or a secure element, in the second network node 102. By storing the indication of the masked target subscription identifier in the second network node 102, there is no need for the first network node 101 to send the masked target subscription identifier to the second network node 102 each time, thus saving power consumption due to processing and reducing processing time.

In one or more embodiments, the indication is the masked target subscription identifier. In one or more embodiments, the indication is a flag indicating the masked target subscription identifier to be used. In one or more embodiments, the indication is a set of masked target subscription identifiers.

Upon receiving the second registration request message comprising the SUCI of the potential target UE 110 and the masked target subscription identifier, at Step 302, the second network node 102 perform a result step of the PSI operation. The result step of the PSI operation has been already described with reference to Step 5 of FIG. 1 as well as with reference to FIG. 2 and not repeated herein.

The result step of the PSI operation, thus, generates a result. The result may be obtained by a result step of the PSI between the masked target subscription identifier and the subscription identifier of the potential target UE. The result may comprise a polynomial obtained by performing a PSI operation between the masked target subscription identifier and the subscription identifier. The result may be obtained as part of a PSI operation described above in the application, for example, as described in Step 2 under the section ‘Private Set Intersection’.

As the next Step 303, the second network node 102 may send an authentication success message to the first network node 101. The authentication success message comprises the result.

In an embodiment, the second network node 102 generates a pseudonymous identifier for the subscription identifier of the potential target UE. The pseudonymous identifier may be used to further increase the privacy of the subscriber's identity wherein the pseudonymous identifier is used for communication and/or computations instead of the subscription identifier of the potential target UE. The pseudonymous identifier may, for example, be a pseudonymized form of one of: the SUPI, the IMSI and the NAI.

FIG. 4 illustrates a method according to one or more embodiments. The method is performed by the LI network node 103. The LI network node 103 may be in the visiting network for the UE 110 that is a potential target UE for the LI network node 103.

It may be desired by the LI network node 103 to determine whether the potential target UE 110 is indeed a target UE. The LI network node 103 typically includes a list of target UEs against which an LEA has issued a warrant for lawful interception. The list of target UEs may be generated at the LI network node 103 based on an indication provided by the LEA or the list of target UEs may be provided to the LI network node 103 by the LEA as part of the LI communication procedure.

Each target UE of the list may be identified by a target subscription identifier. In one or more embodiments, the target subscription identifier is a SUPI. In another embodiment, the target subscription identifier is international mobile subscriber identity, IMSI. In yet another embodiment, the target subscription identifier is a network access identifier, NAI.

At Step 401, the method starts with the LI network node 103 generating an indication of a masked target subscription identifier masked according to a first step of the PSI operation. The masked target subscription identifier is based on the target subscription identifier of the target UE of the list. The masking of the target subscription identifier may be performed as part of a PSI operation (i.e. the first step of the PSI) described above in the application, for example, as described in Step 1 under the section ‘Private Set Intersection’ and/or Steps 2a to 2c of FIG. 1. The masking according to the first step of the PSI operation may, for example, be performed on the list of the target subscription identifiers included in the LI network node 103, as a whole. The first step of the PSI operation may, thus, be performed in the LI network node 103.

The LI network node 103 may generate the indication of the masked target subscription identifier as the masked target subscription identifier itself for the first time. However, when the masked target subscription identifier has previously been sent to the first network node 101 and stored by the first network node 101, the LI network node 103 may generate the indication as a flag identifying the stored masked target subscription identifier. This enables in reducing processing time, saving bandwidth and saving computational power e.g. for performing the masking operation.

As a next Step 402, the LI network node 103 may send the indication of the masked target subscription identifier to the first network node 101. The first network node 101 is in the visiting network for the potential target UE. The visiting network may be the VPLMN. The LI network node 103 may send the indication comprised in a registration indication message.

The next steps take place in the first network node 101 and the second network node 102 according to procedures described above with respect to the FIG. 2 and FIG. 3, respectively.

As a next Step 403 at the LI network node 103, the LI network node 103 may receive, from the first network node 101, a result. The result may be obtained by a result step of the PSI between the masked target subscription identifier and the subscription identifier of the potential target UE 110 performed at the second network node 102 and which was sent to the first network node 101 for forwarding to the LI network node 103. The subscription identifier may be based on a subscription identifier corresponding to the SUCI of the potential target UE.

As a final Step 404, the LI network node 103 may determine whether the subscription identifier of the potential target UE 110 is present as a target subscription identifier of a target UE in the list. The LI network node 103 may determine based on performing a third step, or decryption, of the PSI on the result. The LI network node 103 may further determine the subscription identifier of the potential target UE, that is present in the list, based on the third step of the PSI on the result. The third step of the PSI be performed as part of the PSI operation described above in the application, for example, as described in Step 4 under the section Private Set Intersection and/or Step 7 of FIG. 1.

In one or more embodiments, prior to the step of generating the indication, the LI network node 103 may receive a concealed identifier of the UE 110 that is the potential target UE. The identifier of the UE 110 may be received from the UE 110 or the first network node 101. The identifier of the UE 110 may be received in a registration indication message. In one or more embodiments, the identifier of the UE 110 is the SUCI. In one or more embodiments, the identifier of the UE 110 comprises a first identifier identifying a network and a second identifier identifying a country. The first identifier identifying a network may be a mobile network code and the second identifier identifying a country may be a mobile country code.

From the third step (e.g. decryption), the LI network node 103 verifies whether the SUCI included in the original registration request message is on the LI warrant list.

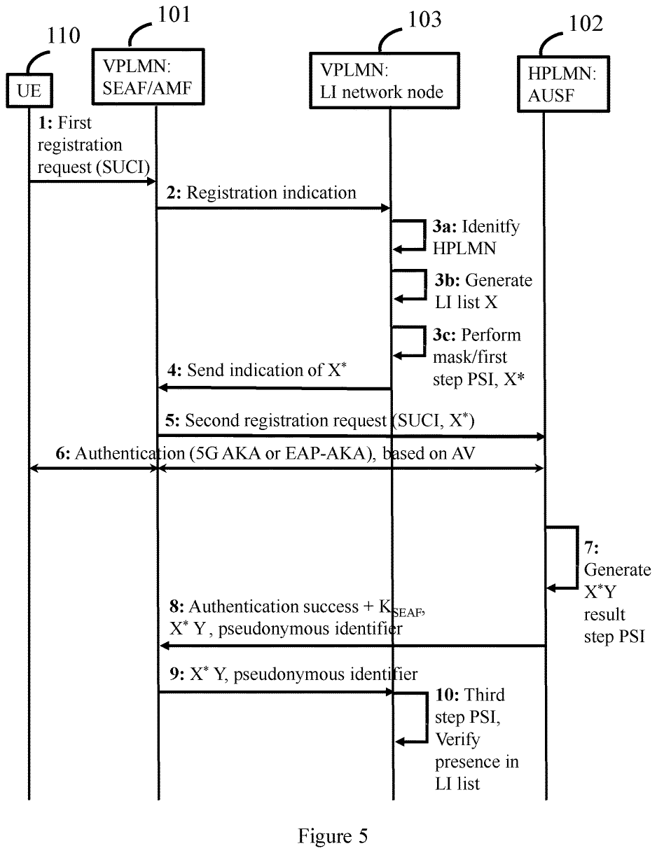

FIG. 5 illustrates a flow chart according to one or more embodiments. The procedure is described below:

Step 1 (optional): The first node in this embodiment is VPLMN SEAF/AMF 101. The VPLMN SEAF/AMF 101 receives a first registration request message from a roaming UE 110, which can be a potential target UE. In this first registration request message, the SUCI of the potential target UE 110 is included. Step 1 may be performed prior to the Step 201 of FIG. 2.

Step 2 (optional): In this embodiment, the second network node 102 is HPLMN AUSF 102. Instead of directly forwarding the first registration request message to the HPLMN AUSF 102, the SEAF/AMF forwards the request to the LI network node 103, in this embodiment VPLMN LI network node 103. Optionally, the first registration request message is not forwarded in its entirety, but only a part of the first registration request message is forwarded. For example, instead of the SUCI; only the MNC and/or MCC are forwarded. Step 2 may be performed prior to the Step 201 of FIG. 2 and/or Step 401 of FIG. 4.

Step 3a (optional): The VPLMN LI network node 103 identifies the HPLMN from the SUCI in the first registration request message, or, if the SUCI is not completely forwarded to the Li node, from the MNC/MCC part of the first registration request message. Step 3a may be performed prior to or as part of the Step 401 of FIG. 4.

Step 3b: The VPLMN LI network node 103 creates a subset of the list of target subscriptions under LI warrant, represented by X, that may be subscriptions of the HPLMN. Typically, only a subset of the whole list of subscriptions (e.g. SUPIs, IMSIs, or NAIs) under LI at the VPLMN LI network node 103 are inserted in the list X. Step 3b may be performed as part of the Step 401 of FIG. 4.

Step 3c: The VPLMN LI network node 103 masks the set X, in accordance with one or more procedures described above, resulting in X*. Step 3b may be performed as part of the Step 401 of FIG. 4.

Step 4: The VPLMN LI network node 103 sends the X* to the VPLMN SEAF/AMF 101 in a registration indication message. Steps 4, 4i and/or 4ii are examples of Step 402 of FIG. 4:
i. Optional: If the VPLMN LI network node 103 has earlier sent a HPLMN-specific set X* to the SEAF/AMF, and there have not been any changes to the set since, the VPLMN LI network node 103 may instead send an indication (e.g. a flag) that the previously received X* may be used.
ii. Optional: If the VPLMN LI network node 103 has earlier provided a HPLMN specific set X*, to SEAF/AMF, and there have been changes to X* since, the VPLMN LI network node 103 may calculate a delta ΔX* between the previously sent set and the updated the set and send the calculated delta.

Step 5: The VPLMN SEAF/AMF 101 sends a second registration request message to the HPLMN AUSF 102. Step 5 is an example of Step 201 of FIG. 2 and/or Step 301 of FIG. 3. The SEAF/AMF also includes X*in the second registration request message:
i. Optional: X* may be a fresh X*, received from the VPLMN LI network node 103.
ii. Optional: If the VPLMN LI network node 103 indicated that previous X*, could be re-used, the SEAF/AMF may send the previously stored X*.
iii. Optional: The SEAF/AMF sends an indication to the HPLMN AUSF 102 that the previously sent X* may be re-used.
iv. Optional: The VPLMN SEAF/AMF 101 periodically includes the X*, even if the X* has already been sent earlier.
v. Optional: The SEAF/AMF sends an indication to the HPLMN that the previously sent X*, may be re-used after applying updated delta. In this case, the delta is provided together with the second registration request message (instead of the complete X*)

Step 6: The 5G authentication may proceed according to standard techniques.

Step 7: The HPLMN AUSF 102 (or possibly the UDM) uses the deconcealed SUPI (based on the SUCI in the second registration request message) as set Y, and generates a PSI operation result which is an application of a function to Y and X* (i.e. a result step of the PSI operation). Step 7 is an example of Step 302 of FIG. 3.

Step 8: Once authentication is successful, the HPLMN AUSF 102 sends an authentication success message to the VPLMN SEAF/AMF 101. The HPLMN AUSF 102 further includes the result in the authentication success message. The authentication success message may further contain the subscription identifier of the UE 110 or a pseudonymized form of the subscription identifier, herein referred as ‘pseudonymous identifier’, of the UE. The authentication success message may further comprise the anchor key KSEAF. Step 8 is an example of Step 303 of FIG. 3 and/or Step 202 of FIG. 2.

Step 9: The VPLMN SEAF/AMF 101 forwards the received result to the VPLMN LI network node 103. The VPLMN SEAF/AMF 101 may further forward the pseudonymous identifier. Step 9 is an example of Step 203 of FIG. 2 and/or Step 403 of FIG. 4.

Step 10: The VPLMN LI network node 103 may determine (e.g. decrypt) the result to verify whether the SUCI included in the first registration request message (or the second registration request message) is on the LI warrant list of the VPLMN LI network node 103. The VPLMN LI network node 103 may further determine the SUPI (to which the SUCI corresponds) that is part of the LI warrant list. The VPLMN LI network node 103 may then start tracking the subscription/session of the UE. The VPLMN LI network node 103 may further determine that the subscription currently uses the pseudonymous identifier in the VPLMN and further store the mapping between the pseudonymous identifier and the subscription identifier in the LI network node 103 for future use. Step 10 is an example of Step 404 of FIG. 4.

It may be noted that there may be other ways for the VPLMN LI network node 103 to make X* available to the VPLMN SEAF/AMF 101. For example, the VPLMN LI network node 103 may generate X* for each HPLMN that the VPLMN has roaming agreement with and publish the X* in a database. The VPLMN SEAF/AMF 101 may fetch matching X* whenever it gets a 5G registration request from a roaming subscription (or a roaming UE). The VPLMN LI network node 103 may then update the X* as and when there are local changes to the target subscriptions under LI.

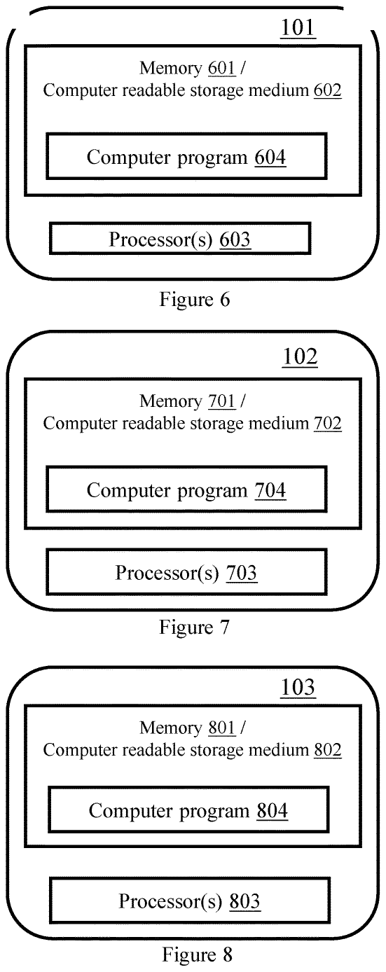

Referring to FIG. 6, the first network node 101 may have storage and/or processing capabilities. The first network node 101 may be configured to control one or more of the methods and/or processes described herein and/or to cause such methods, and/or processes to be performed. Processor 603 corresponds to one or more processors for performing the first network node 101 functions described herein. The first network node 101 includes memory 601 or computer readable storage medium 602 that is configured to store data, programmatic software code and/or other information described herein. In particular, in addition to a traditional processor and memory, the first network node 101 may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 603 may be configured to access, for example, write to and/or read from the memory 601 or the computer readable storage medium 602, which may comprise any kind of volatile and/or non-volatile memory, for example, cache and/or buffer memory and/or RAM (Random Access Memory) and/or ROM (Read-Only Memory) and/or optical memory and/or EPROM (Erasable Programmable Read-Only Memory).

The memory 601 or the computer readable storage medium 602 may include instructions which, when executed by the one or more processors 603, cause the first network node 101 to perform the processes described herein with respect to the first network node 101, for example method(s) described in relation to FIG. 1, FIG. 2 and/or FIG. 5. The instructions may be software (SW) or a computer program associated with the first network node 101.

Thus, the first network node 101 may further comprise SW or a computer program 604, which is stored in, for example, the memory 601 or the computer readable storage medium 602 at the first network node 101, or stored in external memory, for example, database, accessible by the first network node 101. The SW or computer program may be executable by the one or more processors 603.

A computer program product (CPP) 604 in the form of a computer readable storage medium 602 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 603.

Computer readable storage medium 602 may store any suitable instructions, data or information, including a computer program, software, an application including one or more of logic, rules, code, tables, etc. and/or other instructions capable of being executed by one or more processors 603. Computer readable storage medium 602 may be used to store any calculations made by one or more processors 603. In some embodiments, one or more processors 603 and the memory/computer readable storage medium 602 may be considered to be integrated.

Referring to FIG. 7, the second network node 102 may have storage and/or processing capabilities. The second network node 102 may be configured to control one or more of the methods and/or processes described herein and/or to cause such methods, and/or processes to be performed. Processor 703 corresponds to one or more processors for performing the second network node 102 functions described herein. The second network node 102 includes memory 701 or computer readable storage medium 702 that is configured to store data, programmatic software code and/or other information described herein. In particular, in addition to a traditional processor and memory, the second network node 102 may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 703 may be configured to access, for example, write to and/or read from the memory 701 or the computer readable storage medium 702, which may comprise any kind of volatile and/or non-volatile memory, for example, cache and/or buffer memory and/or RAM (Random Access Memory) and/or ROM (Read-Only Memory) and/or optical memory and/or EPROM (Erasable Programmable Read-Only Memory).

The memory 701 or the computer readable storage medium 702 may include instructions which, when executed by the one or more processors 703, cause the second network node 102 to perform the processes described herein with respect to the second network node 102, for example method(s) described in relation to FIG. 1, FIG. 3 and/or FIG. 5. The instructions may be software (SW) or a computer program associated with the second network node 102.

Thus, the second network node 102 may further comprise SW or a computer program 704, which is stored in, for example, the memory 701 or the computer readable storage medium 702 at the second network node 102, or stored in external memory, for example, database, accessible by second network node 102. The SW or computer program may be executable by the one or more processors 703.

A computer program product (CPP) in the form of a computer readable storage medium 702 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 703. Computer readable storage medium 702 may store any suitable instructions, data or information, including a computer program, software, an application including one or more of logic, rules, code, tables, etc. and/or other instructions capable of being executed by one or more processors 703. Computer readable storage medium 702 may be used to store any calculations made by one or more processors 703. In some embodiments, one or more processors 703 and the memory/computer readable storage medium 702 may be considered to be integrated.

Referring to FIG. 8, the LI network node 103 may have storage and/or processing capabilities. The LI network node 103 may be configured to control one or more of the methods and/or processes described herein and/or to cause such methods, and/or processes to be performed. Processor 803 corresponds to one or more processors for performing the LI network node 103 functions described herein. The LI network node 103 includes memory 801 or computer readable storage medium 802 that is configured to store data, programmatic software code and/or other information described herein. In particular, in addition to a traditional processor and memory, the LI network node 103 may comprise integrated circuitry for processing and/or control, for example, one or more processors and/or processor cores and/or FPGAs (Field Programmable Gate Array) and/or ASICs (Application Specific Integrated Circuitry) adapted to execute instructions. The processor(s) 803 may be configured to access, for example, write to and/or read from the memory 801 or the computer readable storage medium 802, which may comprise any kind of volatile and/or non-volatile memory, for example, cache and/or buffer memory and/or RAM (Random Access Memory) and/or ROM (Read-Only Memory) and/or optical memory and/or EPROM (Erasable Programmable Read-Only Memory).

The memory 801 or the computer readable storage medium 802 may include instructions which, when executed by the one or more processors 803, cause the LI network node 103 to perform the processes described herein with respect to the LI network node 103, for example method(s) described in relation to FIG. 1, FIG. 4 and/or FIG. 5. The instructions may be software (SW) or a computer program associated with the LI network node 103.

Thus, the LI network node 103 may further comprise SW or a computer program 804, which is stored in, for example, the memory 801 or the computer readable storage medium 802 at the LI network node 103, or stored in external memory, for example, database, accessible by LI network node 103. The SW or computer program may be executable by the one or more processors 803.

A computer program product (CPP) in the form of a computer readable storage medium 802 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media, for example, a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 803. Computer readable storage medium 802 may store any suitable instructions, data or information, including a computer program, software, an application including one or more of logic, rules, code, tables, etc. and/or other instructions capable of being executed by one or more processors 803. Computer readable storage medium 802 may be used to store any calculations made by one or more processors 803. In some embodiments, one or more processors 803 and the memory/computer readable storage medium 802 may be considered to be integrated.

1-43. (canceled)

44. A method performed by a first network node in a visiting network for a user equipment (UE) that is a potential target UE for a lawful intercept (LI) network node, wherein the LI network node includes a list of target UEs, each target UE of the list being identified by a target subscription identifier, the method comprising:
sending a registration request message for the potential target UE to a second network node, the second network node being part of a home network for the potential target UE, wherein the registration request message comprises a subscription concealed identifier (SUCI) of the potential target UE and an indication of a masked target subscription identifier masked according to a first step of a private set intersection (PSI), and wherein the masked target subscription identifier is based on a target subscription identifier of a target UE of the list;
receiving an authentication success message from the second network node, wherein the authentication success message comprises a result obtained by a result step of the PSI on the masked target subscription identifier and the subscription identifier corresponding to the SUCI of the potential target UE; and
sending the result to the LI network node.

45. The method of claim 44, wherein the method further comprises receiving the SUCI from the potential target UE.

46. The method of claim 44, wherein the authentication success message further comprises a pseudonymous identifier for the subscription identifier of the potential target UE.

47. The method of claim 46, wherein the method further comprises sending the pseudonymous identifier to the LI network node.

48. The method of claim 47, wherein the method further comprises sending the pseudonymous identifier to the LI network node together with the result.

49. The method of claim 44, wherein the method further comprises storing the masked target subscription identifier in the first network node, or storing an indication of the masked target subscription identifier in the first network node.

50. The method of claim 44, wherein the masked target subscription identifier contained in the registration message corresponds to a target UE belonging to the same home network as the potential target UE.

51. A method performed by a second network node in a home network for a user equipment (UE) that is a potential target UE for a lawful intercept (LI) network node, wherein the LI network node includes a list of target UEs, each target UE of the list being identified by a target subscription identifier, the method comprising:
receiving a registration request message for the potential target UE from a first network node in the visiting network, wherein the registration request message comprises a subscription concealed identifier (SUCI) of the potential target UE and an indication of a masked target subscription identifier masked according to a first step of a private set intersection (PSI), and wherein the masked target subscription identifier is based on a target subscription identifier of a target UE of the list;
obtaining a result by a result step of the PSI on the masked target subscription identifier and the subscription identifier corresponding to the SUCI of the potential target UE; and
sending an authentication success message to the first network node, wherein the authentication success message comprises the result.

52. The method of claim 51, wherein the method further comprises generating a pseudonymous identifier for the subscription identifier of the potential target UE.

53. The method of claim 51, wherein the method further comprises storing the masked target subscription identifier in the second network node, or storing an indication of the masked target subscription identifier in the second network node.

54. The method of claim 51, wherein the authentication success message comprises the pseudonymous identifier.

55. The method of claim 51, wherein the second network node is an authentication server function.

56. A method performed by a lawful intercept (LI) network node in a visiting network for a user equipment (UE) that is a potential target UE for the LI network node, wherein the LI network node includes a list of target UEs, each target UE of the list being identified by a target subscription identifier, the method comprising:
generating an indication of a masked target subscription identifier masked according to a first step of a private set intersection (PSI), and wherein the masked target subscription identifier is based on a target subscription identifier of a target UE of the list;
sending an indication of the masked target subscription identifier to a first network node in the visiting network for the potential target UE;
receiving, from the first network node, a result obtained by a result step of the PSI on the masked target subscription identifier and the subscription identifier corresponding to the SUCI of the potential target UE; and
determining whether the subscription identifier of the potential target UE is present as a target subscription identifier of a target UE in the list based on performing a third step of the PSI on the result.

57. The method of claim 56, wherein the method further comprises receiving a registration indication message comprising an identifier of the UE.

58. The method of claim 57, wherein the identifier comprises a first identifier identifying a network and a second identifier identifying a country.

59. The method of claim 57, wherein the identifier is the SUCI.

60. The method of claim 56, wherein the method further comprises receiving a pseudonymous identifier for the subscription identifier of the UE.

61. The method of claim 56, wherein the method further comprises:
associating the pseudonymous identifier with the subscription identifier of the UE; and
performing lawful interception on the UE.

62. The method of claim 56, wherein the masked target subscription identifier or the indication of the masked target subscription identifier is stored in at least one of: the first network node and the second network node.

63. A non-transitory computer readable storage medium storing a first computer program, a second computer program, or a third computer program, wherein
the first computer program comprises instructions for configuring a first network node in a visiting network to perform a first method for a user equipment (UE) that is a potential target UE for a lawful intercept (LI) network node, wherein the LI network node includes a list of target UEs, each target UE of the list being identified by a target subscription identifier, the first method comprising:
sending a registration request message for the potential target UE to a second network node, the second network node being part of a home network for the potential target UE, wherein the registration request message comprises a subscription concealed identifier (SUCI) of the potential target UE and an indication of a masked target subscription identifier masked according to a first step of a private set intersection (PSI), and wherein the masked target subscription identifier is based on a target subscription identifier of a target UE of the list;
receiving an authentication success message from the second network node, wherein the authentication success message comprises a result obtained by a result step of the PSI on the masked target subscription identifier and the subscription identifier corresponding to the SUCI of the potential target UE; and
sending the result to the LI network node,
the second computer program comprises instructions for configuring the second network node to perform a second method comprising:
receiving the registration request message for the potential target UE from the first network node in the visiting network;
obtaining the result by a result step of the PSI on the masked target subscription identifier and the subscription identifier corresponding to the SUCI of the potential target UE; and
sending the authentication success message to the first network node, wherein the authentication success message comprises the result, and
the third computer program comprises instructions for configuring the LI network node to perform a third method comprising:
generating the indication of the masked target subscription identifier;
sending the indication of the masked target subscription identifier to the first network;
receiving, from the first network node, the result; and
determining whether the subscription identifier of the potential target UE is present as a target subscription identifier of a target UE in the list based on performing a third step of the PSI on the result.
